(19) United States
(12) Patent Application Publication
(10) Pub. No.: US 2024/0227427 A9
(43) Pub. Date: Jul. 11, 2024

(54) MULTI-SPECTRAL WATERMARK

(71) Applicant: Xerox Corporation, Norwalk, CT (US)

(72) Inventor: Edward N. Chapman, Rochester, NY (US)

(21) Appl. No.: 17/970,857

(22) Filed: Oct. 21, 2022

(51) Int. Cl. B42D 25/333; B41M 3/10; B42D 25/382; B42D 25/387

(52) U.S. Cl. CPC B42D 25/333; B41M 3/10; B42D 25/382; B42D 25/387

(57) ABSTRACT

A multispectral watermark and method for generating the multispectral watermark. A color pattern can be provided, which appears a single color/pattern under a first lighting condition. A watermark can be created based on the color pattern and under a second lighting condition comprising ultraviolet light, while the watermark is viewable with an infrared camera in an infrared spectrum. The watermark can be configured as a multispectral watermark with a metameric pair of inks with one ink of the metameric pair of inks using more CMYK toners that reflect in the infrared spectrum as compared to the other ink among the metameric pair of inks while simultaneously allowing more of the ultraviolet light or less of the ultraviolet light to reach a fluorescing media upon which the multispectral watermark is rendered.

### TECHNICAL FIELD

Embodiments are related to image processing methods, systems and devices. Embodiments also relate to printing devices and techniques. Embodiments further relate to security devices such as watermarks. Embodiments are further related to multispectral watermarks.

### BACKGROUND

In conventional printing processes that require security measures, a pattern color space having specialty imaging characteristics can be used to provide security measures and prevent counterfeiting of printed materials. Furthermore, in conventional printing processes, a pattern color space can be used, in part on variable data, such as printing logos, serial numbers, seat locations, or other types of unique identifying information on printed materials.

Security is an important requirement in many document production applications. In situations such as official or government document printing, event ticket printing, financial instrument printing and the like, many documents must be protected against copying, forging and/or counterfeiting. To accomplish this, printed documents often include security marks or security features that serve to prevent counterfeiting and/or identify a document as original.

Thus, in security applications, it may be desirable to add information to a document in the form of a security mark or a security feature that may prevent or hinder alterations and counterfeiting. Specialty imaging has been used, conventionally, in printed materials to provide fraud protection and anti-counterfeiting measures for such security applications. Some examples include prescriptions, contracts, documents, coupons, and tickets. Typically, several specialty-imaging techniques can be used at various positions in a document. In addition, these security elements may in some cases conflict with the overall aesthetics of the document.

Specialty imaging can include the use of spectral watermarks such as infrared (IR) and ultraviolet (UV). These are expected to appear as a single color/pattern under office lighting with a visible watermark under, for example, UV light. Each has advantages and disadvantages such as UV being viewable with an inexpensive UV flashlight. IR has better resolution and lends itself to machine readable automatic verification such as barcodes. To take advantage of both UV and IR requires two separate watermarks with both taking up valuable real estate on a document.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the embodiments to provide for an improved security apparatus such as a watermark.

It is another aspect of the embodiments to provide for improved image processing methods, systems and devices.

It is yet another aspect of the embodiments to provide for improved methods and systems for rendering watermarks used for securing documents.

It also an aspect of the embodiments to provide for a security apparatus comprising a multispectral watermark.

The aforementioned aspects and other objectives and advantages can now be achieved as described herein. In an embodiment, a method for generating a multispectral watermark, can involve: providing a color pattern that appears a single color/pattern under a first lighting condition; creating a watermark based on the color pattern and under a second lighting condition comprising ultraviolet light, while the watermark is viewable with an infrared camera in an infrared spectrum; and configuring the watermark as a multispectral watermark with a metameric pair of inks with one ink of the metameric pair of inks using more CMYK toners that reflect in the infrared spectrum as compared to the other ink among the metameric pair of inks while simultaneously allowing more of the ultraviolet light or less of the ultraviolet light to reach a fluorescing media upon which the multispectral watermark is rendered.

In an embodiment, the multispectral watermark is visible with an IR camera.

In an embodiment, the multispectral watermark can be visible with the IR camera or with the ultraviolet light.

In an embodiment, the first lighting condition can involve office illumination.

An embodiment can further involve creating the metameric pair of inks wherein one ink among the metameric pair of inks reflects high in the infrared spectrum as compared to the other ink among the metameric pair of inks using solid colors of CMYKRGBP (P=paper/white) or at least one spot.

In an embodiment, the metameric pair of inks may appear as the single color/pattern at a printed size.

In an embodiment, the fluorescing media can comprise paper.

In another embodiment, a system for generating a multispectral watermark, can include at least one processor and a memory, the memory storing instructions to cause the at least one processor to perform: providing a color pattern that appears a single color/pattern under a first lighting condition; creating a watermark based on the color pattern and under a second lighting condition comprising ultraviolet light, while the watermark is viewable with an infrared camera in an infrared spectrum; and configuring the watermark as a multispectral watermark with a metameric pair of inks with one ink of the metameric pair of inks using more CMYK toners that reflect in the infrared spectrum as compared to the other ink among the metameric pair of inks while simultaneously allowing more of the ultraviolet light or less of the ultraviolet light to reach a fluorescing media upon which the multispectral watermark is rendered.

In another embodiment, a security apparatus, can comprise: a color pattern that appears a single color/pattern under a first lighting condition; a watermark created based on the color pattern and under a second lighting condition comprising ultraviolet light, while the watermark is viewable with an infrared camera in an infrared spectrum; and the watermark comprising a multispectral watermark created with a metameric pair of inks with one ink of the metameric pair of inks using more CMYK toners that reflect in the infrared spectrum as compared to the other ink among the metameric pair of inks while simultaneously allowing more of the ultraviolet light or less of the ultraviolet light to reach a fluorescing media upon which the multispectral watermark is rendered.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention.

FIG. 1 illustrates an image of an example infrared (IR) product with a background textbox composed of RBCM (red/blue/cyan/magenta) and sample text “XE” adding K (black) but with a loss of CR, and magenta is a common color;

FIG. 2 illustrates an image of an IR swatch sheet under office illumination, in accordance with an embodiment;

FIG. 3 illustrates an image of an IR swatch sheet with an IR camera, in accordance with an embodiment;

FIG. 4 illustrates an image of the same concert ticket with a UV light and under office lighting, in accordance with an embodiment;

FIG. 5 illustrates an image of a multispectral watermark, in accordance with an embodiment;

FIG. 6 illustrates an image of a multispectral watermark zoomed, in accordance with an embodiment;

FIG. 7 illustrates an image of a multispectral watermark with office illumination, in accordance with an embodiment;

FIG. 8 illustrates an image of a swatch sheet with UV illumination;

FIG. 9 illustrates an image of the same swatch sheet depicted in FIG. 8 with an IR camera, in accordance with an embodiment;

FIG. 10 illustrates a high-level flow chart of operation depicting logical operational steps of a method for configuring a multispectral watermark, in accordance with an embodiment;

FIG. 11 illustrates a block diagram of a printing system suitable for implementing one or more of the disclosed embodiments; and

FIG. 12 illustrates a block diagram of a digital front-end controller useful for implementing one or more of the disclosed embodiments.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Furthermore, the term “at least one” as utilized herein can refer to “one or more”. For example, “at least one widget” may refer to “one or more widgets.”

The term “data” refers herein to physical signals that indicate or include information. An “image,” as a pattern of physical light or a collection of data representing the physical light, may include characters, words, and text as well as other features such as graphics.

A “digital image” is by extension an image represented by a collection of digital data. An image may be divided into “segments,” each of which is itself an image. A segment of an image may be of any size up to and including the whole image. The term “image object” or “object” as used herein is believed to be considered in the art generally equivalent to the term “segment” and will be employed herein interchangeably.

In a digital image composed of data representing physical light, each element of data may be called a “pixel,” which is common usage in the art and refers to a picture element. Each pixel has a location and value. Each pixel value is a bit in a “binary form” of an image, a gray scale value in a “gray scale form” of an image, or a set of color space coordinates in a “color coordinate form” of an image, the binary form, gray scale form, and color coordinate form each being a two-dimensional array defining an image. An operation can perform “image processing” when it operates on an item of data that relates to part of an image.

The term “metameric” as utilized herein can relate to a metameric pair of pattern ink. In a metameric pair of pattern ink (also referred to simply as a “metameric pair”) the printing and paper are not visually distinguishable when viewed from one angle but are from another angle (relative to a light source) which can create a watermark without more expensive spot inks, toners, and/or printers.

The term “watermark” as utilized herein can relate to a piece of a transparent text, image, logo or other markings that can be applied to media (e.g., a document, paper, a photo, an image, etc.), which can make it more difficult to copy or counterfeit the media (to which the watermark is applied through security printing) or use it without permission. A “watermark” can be a special-purpose text or picture that can be printed across one or more pages. For example, one can add a word like Copy, Draft, or Confidential as a watermark instead of stamping it on a document before distribution.

In the area of security printing, documents can be protected from copying, forging and counterfeiting using multiple techniques. Specialty imaging is one such method of security printing, which can use standard material such as papers inks and toners. Typically, security-printing companies in the marketplace require special (expensive) materials. An example document is a prescription where a pharmacist would like to be able to have a satisfactory level of confidence that the document is genuine.

As will be discussed in greater detail below, a new multispectral watermark that appears as a single color/pattern under office lighting and creates a watermark under UV light while viewing the same watermark with an IR camera can be created. In this approach, a metameric pair of inks can be configured with one ink using more CMYK toners that reflect in the IR spectrum as compared to the other while at the same time allowing more UV light to reach the fluorescing media as compared to the other. The converse is also true, meaning that the last sentence can be changed to “allowing less UV”.

Note that the term “fluorescing” as utilized herein relates to fluorescence, which is the emission of light by a substance that has absorbed light or other electromagnetic radiation. Fluorescence is a form of luminescence. In most cases, the emitted light has a longer wavelength, and therefore a lower photon energy, than absorbed radiation. A perceptible example of fluorescence occurs when the absorbed radiation is in the UV region of the electromagnetic spectrum (invisible to the human eye), while the emitted light is in the visible region; this gives the fluorescent substance a distinct color that can only be seen when the substance has been exposed to UV light. Fluorescent materials cease to glow nearly immediately when the radiation source stops, unlike phosphorescent materials, which continue to emit light for some time after.

In the area of security printing, documents are protected from copying, forging, and counterfeiting using multiple techniques. Specialty Imaging is one such method of security printing which uses standard material such as papers inks and toners. Typically, security printing companies in the marketplace require special (expensive) materials. An example document is a prescription where a pharmacist would like to be able to have a good level of confidence that the document is genuine.

Information on Specialty Imaging including infrared mark text and ultra violet mark text can be found at this webpage: https://www.xerox.com/en-us/digital-printing/secure-printing, which is incorporated herein by reference in its entirety. A design goal of a metameric pair of IR inks is to appear to be about the same color/pattern under office illumination. That is, text and/or other graphics can become visible with an IR camera.

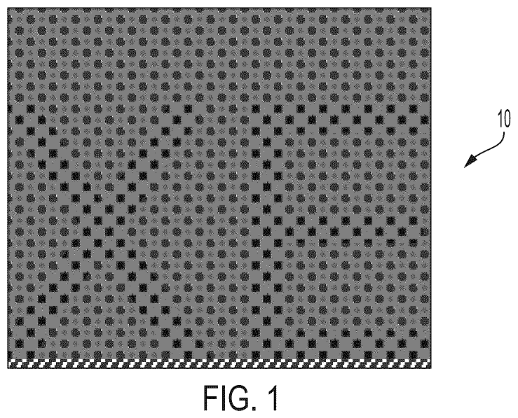

FIG. 1 illustrates an image 10 of an example infrared (IR) product with a background textbox composed of RBCM (red/blue/cyan/magenta) and sample text “XE” adding K (black) but with a loss of CR, and magenta as a common color. At normal print size of 7/16″ both patterns appear to be about the same but zooming in shows the details and the text “XE” can be seen. Note that all colors are 100% on spot colors.

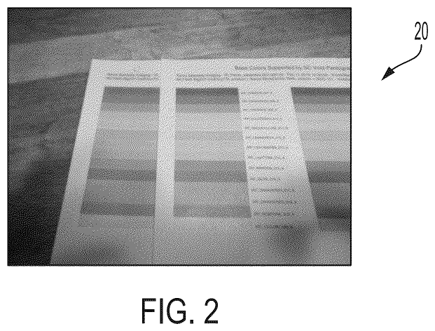

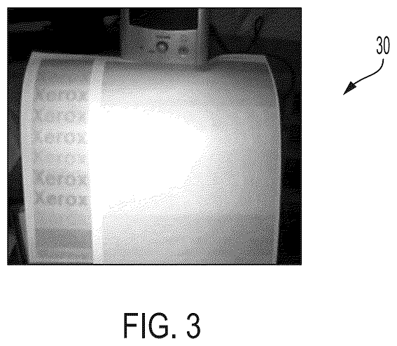

FIG. 2 illustrates an image 20 of an IR swatch sheet under office illumination, in accordance with an embodiment. FIG. 3 illustrates an image 20 of an IR swatch sheet with an IR camera, in accordance with an embodiment. FIG. 2 and FIG. 3 show the same pieces of paper under different lighting conditions. A single pair of metameric pattern inks such as shown in image 20 of FIG. 1 can make up one color on the swatch sheet. To be considered a working color, the watermark should be mostly invisible in the image 20 of FIG. 2 and mostly readable in the image 30 of FIG. 3.

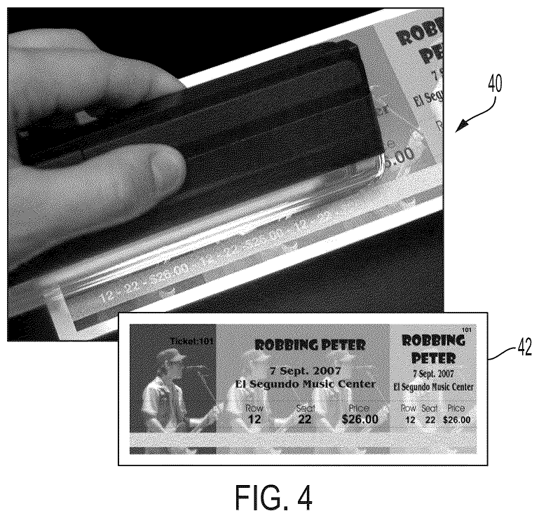

FIG. 4 illustrates an image 40 of the same concert ticket with a UV light and under office lighting, in accordance with an embodiment. Like IR the watermark is mostly invisible under office lighting and mostly visible with UV illumination.

The following steps outline a general methodology for creating a multispectral watermark, in accordance with the embodiments:
1) Create a metameric pair of pattern inks where one ink reflects higher in the IR spectrum as compared to the other using solid colors of CMYKRGBP (P=paper/white) or spot(s);
2) In addition, the pair of inks should appear to be a single color/pattern at printed size;
3) Use more paper (white) in one ink as compared to the other to allow more UV light to pass;
4) Use darker spots for the ink of step 3 to compensate for the white paper under office illumination;
5) Use lighter spots in the other ink;
6) The two inks from steps 4 and 5 should appear as about the same color/pattern under office lighting; and
7) A watermark should be visible with an IR camera and with a UV light

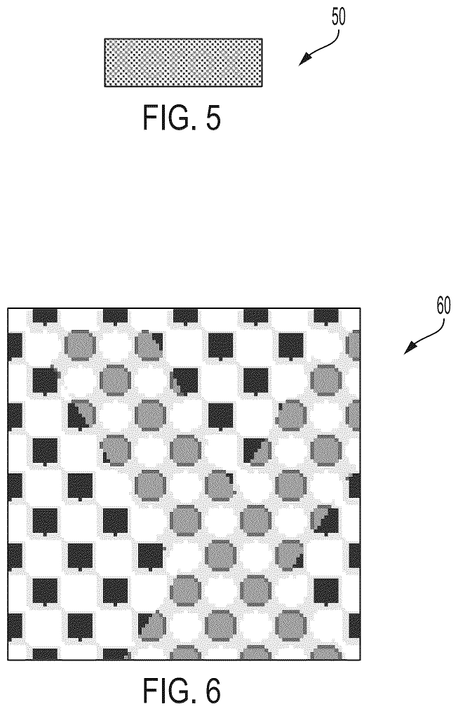

FIG. 5 illustrates an image 50 of a multispectral watermark, in accordance with an embodiment. This should be difficult to read at printed sizes. For some toners black has a different spectral reflectance in the IR spectrum as compared to other standard toners. A simple model can involve using more of the color black in one of the two metameric IR inks such as in the image 10 of FIG. 1.

The UV model may not be quite as simple as using more paper in one ink as CMY has a partial spectral reflectance in the UV spectrum. Paper/white difference may be the strongest contributor to creating a UV watermark. White is not often used in current IR product as shown in FIGS. 1, 2, and 3, but can be used in the image 40 of FIG. 4 for the UV watermark. Due to using more of the lightest possible color of white the overall ink is darkened so it the pair of inks appear about the same under office lighting.

FIG. 6 illustrates an image 60 of a multispectral watermark zoomed, in accordance with an embodiment. The image 60 depicted in FIG. 6 shows a piece of the image 50 of FIG. 5 but zoomed. The ink in the center is part of an “X” and composed of CMYP. The other ink is composed of YKP. It absorbs more in the IR spectrum due to the spectral reflectance of K verse CMY as compared to the first ink. This approach also allows more UV light as compared to the first ink. That is, this approach allows more UV light to reach paper (or other media) causing a greater fluorescence. When zoomed one can see how much the two inks differ even though they appear about the same at printed sizes like halftones. Using a common color like yellow and white and similar shapes such as black and cyan near squares aids in the pair of metameric inks appearing to be about the same color/pattern at printed size with office illumination.

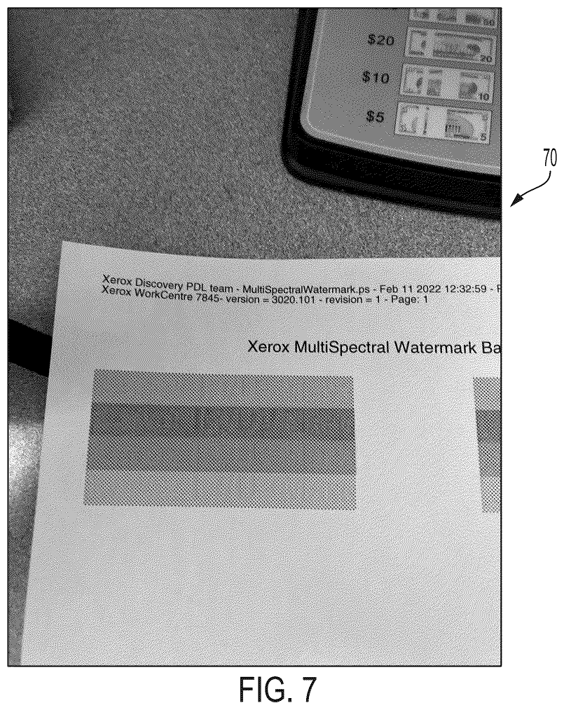

FIG. 7 illustrates an image 70 of a multispectral watermark with office illumination, in accordance with an embodiment. A swatch sheet with 4 metameric pairs is shown in image 70 of FIG. 7. On different printers and monitors at different size/zoom levels each patch may appear invisible (pass) or readable (fail). With rendering by, for example, an Altalink product, the top patch appears readable, but the other three work. On a 7845MFD all four patches work. Note that the term “Atalink” as utilized herein refers to an AltaLink® All-in-One printer.

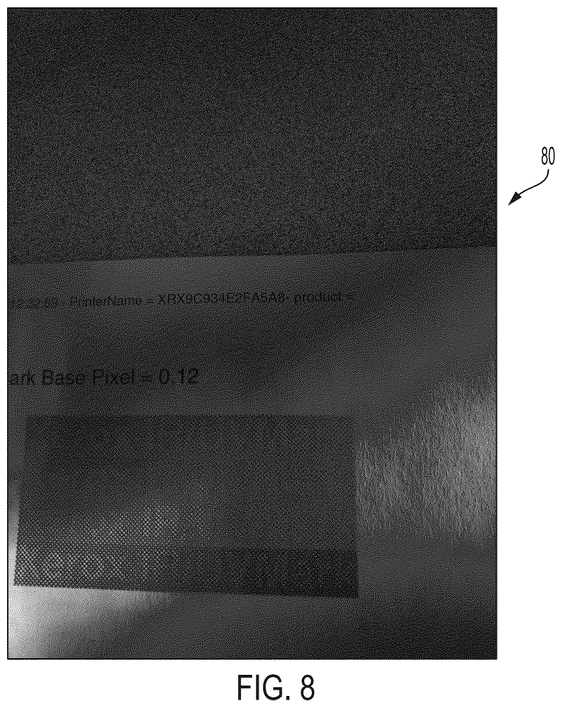

FIG. 8 illustrates an image 80 of a swatch sheet with UV illumination. Note that all 4 patches are readable, but the top patch had previously failed so would be removed for an Altalink product. The contrast of the florescent watermark can be improved but makes hiding under office illumination (e.g., a design tradeoff).

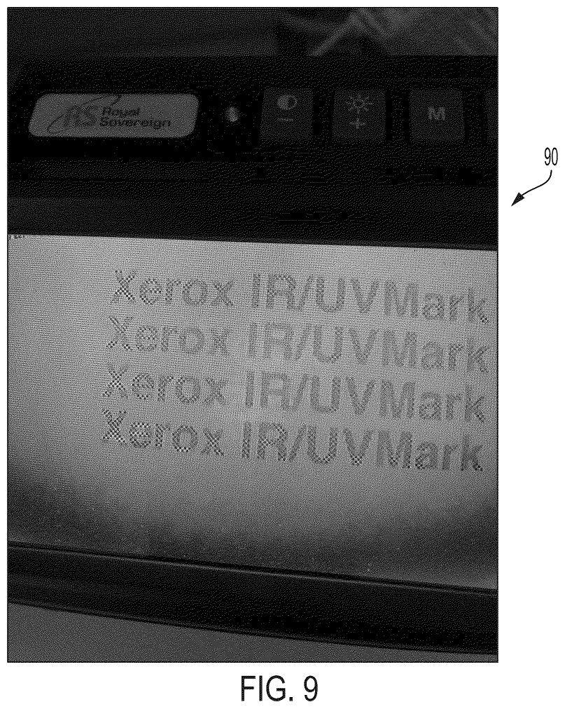

FIG. 9 illustrates an image 90 of the same swatch sheet depicted in FIG. 8 with an IR camera, in accordance with an embodiment. All four swatches work with IR. Note that some of advantages of the disclosed multispectral watermark can include the fact that the multispectral watermark is to verify with a simple UV flashlight and can also be used to encode higher resolution watermarks such as 2D barcodes. Furthermore, the disclosed multispectral watermark can be subject to machine readable verification especially w/IR. In addition, a counterfeiter may be fooled by defeating IR or UV alone. The disclosed multispectral watermark also uses less real estate as compared to a UV watermark and an IR watermark.

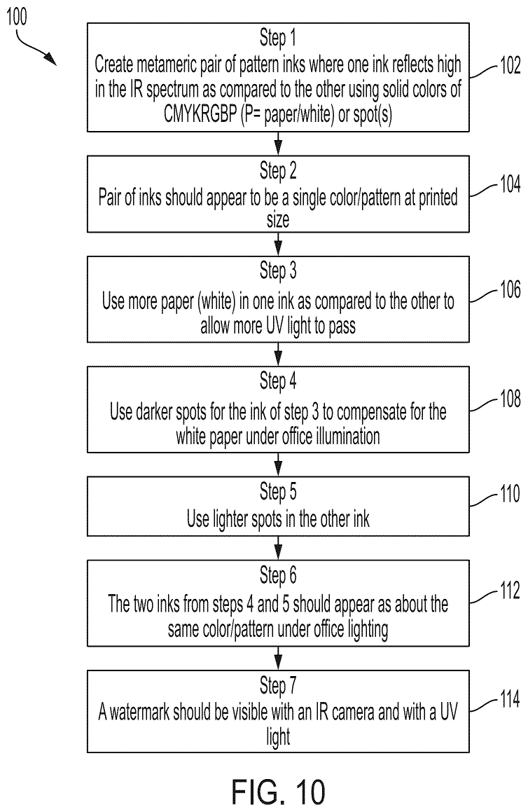

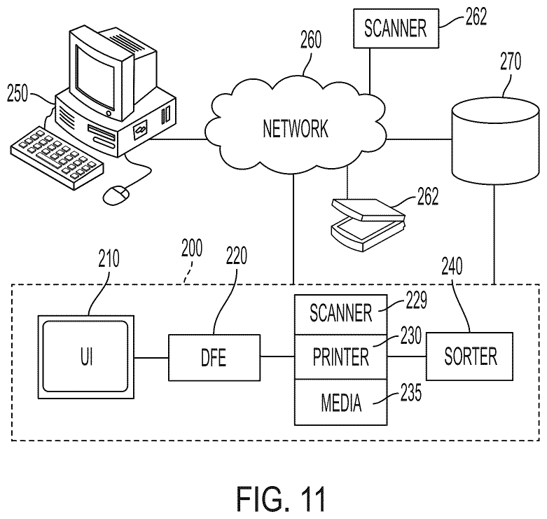

FIG. 10 illustrates a high-level flow chart of operation depicting logical operational steps of a method 100 for configuring a multispectral watermark, in accordance with an embodiment. As shown at block 102 (i.e., Step 1), a step or operation can be implemented to create a metameric pair of pattern inks where one ink reflects higher in the IR spectrum as compared to the other using solid colors of CMYKRGBP (P=paper/white) or spot(s). Next, as illustrated at block 104 (i.e., Step 2), the pairs of ink should appear to be a single color/pattern at printed size. Thereafter, as depicted at block 106 (i.e., Step 3), a step or operation can be implemented involving the use of more paper (white) in one ink as compared to the other to allow more UV light to pass.

Next, as described at block 108 (i.e., Step 4), a step or operation can be implemented involving the use of darker spots for the ink of Step 3 to compensate for the white paper under office illumination. Then, as indicated at block 110 (i.e., Step 5), a step or operation can be implemented involving the use of lighter spots in the other ink. Thereafter, as illustrated at block 112 (i.e., Step 6), a step or operation can be implemented in which the two inks from Steps 4 and 5 should appear as about the same color/pattern under office lighting. Finally, as depicted at block 114 (Step 7), a step or operation can be implemented in which a multispectral watermark should be visible with an IR camera and with a UV light.

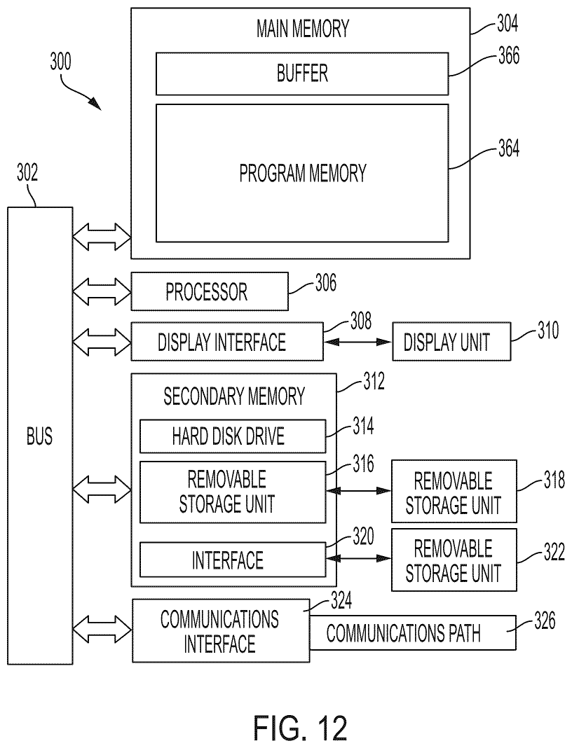

FIG. 11 illustrates a block diagram of a printing system 200 suitable for implementing one or more of the disclosed embodiments. FIG. 12 illustrates a block diagram of a digital front-end controller 300 useful for implementing one or more of the disclosed embodiments.

With reference to FIG. 11, a printing system (or image rendering system) 200 suitable for implementing various aspects of the exemplary embodiments described herein is illustrated. The printing system 200 can implement rendering operations such as scanning a document via a scanner and printing a document via a printer, wherein the document includes the disclosed two-layer correlation mark with a variable data hiding layer.

The printing system 200 can be used to render an image in which a variable data layer is added to correlation marks, allowing a second layer of variable data to be printed where previously there was only one. This concept is an extension of the use of a correlation mark using vector patterns with a ‘hiding layer’, which better hides the edges of the correlation mark. The ‘hiding layer’ can be composed of a variable data stream. Benefits of the embodiments include the use of an extra variable data layer in the space where previously only the correlation mark data was encoded.

Note that the term ‘scanner’ as utilized herein can refer to an image scanner, which is a device or system that can optically scan images, printed text, handwriting or an object and converts it to a digital image. An example of a scanner is a flatbed scanner where the document to be imaged (e.g., a form) can be placed on a glass window for scanning. The scanner may in some cases be incorporated into a multi-function device (MFD), which also may possess printing and photocopying features. The scanner may also be incorporated into, for example, a printing system such as the printing system 200 shown in FIG. 11. For example, the scanner 229 is shown in FIG. 7 as a part of the printing system 200. Alternatively, or in addition to the scanner 229 included as a part of the printing system 100, a scanner may be implemented as a separate scanner 262 also depicted in FIG. 11, which can communicate with the network 260.

The word “printer” and the term “printing system” as used herein can encompass any apparatus and/or system; such as a digital copier, xerographic and reprographic printing systems, bookmaking machine, facsimile machine, multi-function machine, ink-jet machine, continuous feed, sheet-fed printing device, etc.; which may contain a print controller and a print engine and which may perform a print outputting function for any purpose.

The printing system 200 can include a user interface 210, a digital front-end (DFE) controller 220, and at least one print engine 230. The print engine 230 has access to print media 235 of various sizes and cost for a print job. The printing system 200 can comprise a color printer having multiple color marking materials.

A “print job” or “document” is normally a set of related sheets, usually one or more collated copy sets copied from a set of original print job sheets or electronic document page images, from a particular user, or otherwise related. For submission of a regular print job (or customer job), digital data can be sent to the printing system 200.

A sorter 240 can operate after a job is printed by the print engine 230 to manage arrangement of the hard copy output, including cutting functions. A user can access and operate the printing system 200 using the user interface 210 or via a data-processing system such as a workstation 250. The workstation 250 can communicate bidirectionally with the printing system 200 via a communications network 260.

A user profile, a work product for printing, a media library, and various print job parameters can be stored in a database or memory 270 accessible by the workstation 250 or the printing system 200 via the network 260, or such data can be directly accessed via the printing system 200. One or more color sensors (not shown) may be embedded in the printer paper path, as known in the art.

With respect to FIG. 12, an exemplary DFE (Digital Front End) controller 300 is shown in greater detail. The DFE controller 300 can include one or more processors, such as processor 306 capable of executing machine executable program instructions. The processor 306 can function as a DFE processor.

In the embodiment shown, the processor 306 can be in communication with a bus 302 (e.g., a backplane interface bus, cross-over bar, or data network). The digital front end 300 can also include a main memory 304 that is used to store machine readable instructions. The main memory 304 is also capable of storing data. The main memory 304 may alternatively include random access memory (RAM) to support reprogramming and flexible data storage. A buffer 366 can be used to temporarily store data for access by the processor 306.

Program memory 364 can include, for example, executable programs that can implement the embodiments described herein. The program memory 364 can store at least a subset of the data contained in the buffer. The digital front end 300 can include a display interface 308 that can forward data from a communication bus 302 (or from a frame buffer not shown) to a display 310. The digital front end 300 can also include a secondary memory 312 that can include, for example, a hard disk drive 314 and/or a removable storage drive 316, which can read and write to removable storage 318, such as a floppy disk, magnetic tape, optical disk, etc., that stores computer software and/or data.

The secondary memory 312 alternatively may include other similar mechanisms for allowing computer programs or other instructions to be loaded into the computer system. Such mechanisms can include, for example, a removable storage unit 322 adapted to exchange data through interface 320. Examples of such mechanisms include a program cartridge and cartridge interface (such as that found in video game devices), a removable memory chip (such as an EPROM, or PROM) and associated socket, and other removable units and interfaces, which allow software and data to be transferred.

The digital front end (DFE) controller 300 can include a communications interface 324, which can act as an input and an output to allow software and data to be transferred between the digital front end controller 300 and external devices. Examples of a communications interface include a modem, a network interface (such as an Ethernet card), a communications port, a PCMCIA slot and card, etc.

Computer programs (also called computer control logic) and including one or more modules may be stored in the main memory 304 and/or the secondary memory 312. Computer programs or modules may also be received via a communications interface 324. Such computer programs or modules, when executed, enable the computer system to perform the features and capabilities provided herein. Software and data transferred via the communications interface can be in the form of signals which may be, for example, electronic, electromagnetic, optical, or other signals capable of being received by a communications interface.

These signals can be provided to a communications interface via a communications path (i.e., channel), which carries signals and may be implemented using wire, cable, and fiber optic, phone line, cellular link, RF, or other communications channels.

Part of the data stored in secondary memory 312 for access during a DFE operation may be a set of translation tables that can convert an incoming color signal into a physical machine signal.

This color signal can be expressed either as a colorimetric value; usually three components as L*a*b*, RGB, XYZ, etc.; into physical exposure signals for the four toners cyan, magenta, yellow and black. These tables can be created outside of the DFE and downloaded but may be optionally created inside the DFE in a so-called characterization step.

Several aspects of data-processing systems will now be presented with reference to various systems and methods. These systems and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A mobile “app” is an example of such software.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer.

The disclosed example embodiments are described at least in part herein with reference to flowchart illustrations and/or block diagrams and/or schematic diagrams of methods, systems, and computer program products and data structures according to embodiments of the invention. It will be understood that each block of the illustrations, and combinations of blocks, can be implemented by computer program instructions. These computer program instructions may be provided to a processor of, for example, a general-purpose computer, special-purpose computer, or other programmable data processing apparatus to produce a machine, such that the instructions, which execute via the processor of the computer or other programmable data processing apparatus, create means for implementing the functions/acts specified in the block or blocks.

To be clear, the disclosed embodiments can be implemented in the context of, for example a special-purpose computer or a general-purpose computer, or other programmable data processing apparatus or system. For example, in some example embodiments, a data processing apparatus or system can be implemented as a combination of a special-purpose computer and a general-purpose computer. The computer program product may include a computer readable storage medium (or media) having computer readable program instructions thereon for causing a processor to carry out aspects of the embodiments.

The aforementioned computer program instructions may also be stored in a computer-readable memory that can direct a computer or other programmable data processing apparatus to function in a particular manner, such that the instructions (e.g., steps/operations) stored in the computer-readable memory produce an article of manufacture including instruction means which implement the function/act specified in the various block or blocks, flowcharts, and other architecture illustrated and described herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

The flow charts and block diagrams in the figures illustrate the architecture, functionality, and operation of possible implementations of systems, methods, and computer program products according to various embodiments (e.g., preferred or alternative embodiments). In this regard, each block in the flow chart or block diagrams depicted and described herein can represent a module, segment, or portion of instructions, which can comprise one or more executable instructions for implementing the specified logical function(s).

In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The functionalities described herein may be implemented entirely and non-abstractly as physical hardware, entirely as physical non-abstract software (including firmware, resident software, micro-code, etc.) or combining non-abstract software and hardware implementations that may be referred to herein as a “circuit,” “module,” “engine”, “component,” “block”, “database”, “agent” or “system.” Furthermore, aspects of the present disclosure may take the form of a computer program product embodied in one or more non-ephemeral computer readable media having computer readable and/or executable program code embodied thereon.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” (also referred to as an “engine”) may constitute a software application but can also be implemented as both software and hardware (i.e., a combination of software and hardware).

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular data type. Modules may be composed of two parts: an interface, which lists the constants, data types, variable, and routines that can be accessed by other modules or routines, and an implementation, which may be typically private (accessible only to that module) and which includes source code that actually implements the routines in the module. The term module may also simply refer to an application, such as a computer program designed to assist in the performance of a specific task, such as word processing, accounting, inventory management, etc.

In some example embodiments, the term “module” can also refer to a modular hardware component or a component that is a combination of hardware and software. It should be appreciated that implementation and processing of such modules according to the approach described herein can lead to improvements in processing speed and in energy savings and efficiencies in a data-processing system such as, for example, the printing system 200 shown in FIG. 11 and/or the DFE controller 300 shown in FIG. 8. A “module” can perform the various steps, operations or instructions discussed herein, such as the steps or operations discussed herein with respect to FIG. 1 to FIG. 10.

The method 100 shown in FIG. 10, for example, may be implemented, in part, in a computer program product comprising a module that may be executed by, for example, DFE controller 220 discussed previously with respect to FIG. 11. The computer program product may comprise a non-transitory computer-readable recording medium on which a control program can be recorded (e.g., stored), such as a disk, hard drive, or the like. Note that the term ‘recording medium’ as utilized herein can relate to such a non-transitory computer-readable recording medium.

Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the DFE controller 220 (for example, an internal hard drive of RAM), or may be separate (for example, an external hard drive operatively connected with the printer), or may be separate and accessed via a digital data network such as a local area network (LAN) or the Internet (e.g., as a redundant array of inexpensive or independent disks (RAID) or other network server storage that can be indirectly accessed by the DFE controller 220, via a digital network such as the network 260 shown in FIG. 11).

It is understood that the specific order or hierarchy of steps, operations, or instructions in the processes or methods disclosed is an illustration of exemplary approaches. For example, the various steps, operations or instructions discussed herein can be performed in a different order. Similarly, the various steps and operations of the disclosed example pseudo-code discussed herein can be varied and processed in a different order. Based upon design preferences, it is understood that the specific order or hierarchy of such steps, operation or instructions in the processes or methods discussed and illustrated herein may be rearranged. The accompanying claims, for example, present elements of the various steps, operations or instructions in a sample order, and are not meant to be limited to the specific order or hierarchy presented.

The inventors have realized a non-abstract technical solution to the technical problem to improve a computer-technology by improving efficiencies in such computer technology. The disclosed embodiments offer technical improvements to a computer-technology such as a data-processing system, and further provide for a non-abstract improvement to a computer technology via a technical solution to the technical problem(s) identified in the background section of this disclosure. Such improvements can result from implementations of the embodiments. The claimed solution may be rooted in computer technology in order to overcome a problem specifically arising in the realm of computers, computer networks, and printing and scanning. The claimed solution may also involve non-abstract devices such as security devices including non-abstract features such as printed media (e.g., paper) upon which the security device (e.g., a watermark) may be rendered. That is, a watermark rendered upon media is a non-abstract device.

Based on the foregoing, it can be appreciated that a number of embodiments are disclosed herein, including preferred and alternative embodiments. For example, in an embodiment, a method for generating a multispectral watermark, can involve providing a color pattern that appears a single color/pattern under a first lighting condition; creating a watermark based on the color pattern and under a second lighting condition comprising ultraviolet light, while the watermark is viewable with an infrared camera in an infrared spectrum; and configuring the watermark as a multispectral watermark with a metameric pair of inks with one ink of the metameric pair of inks using more CMYK toners that reflect in the infrared spectrum as compared to the other ink among the metameric pair of inks while simultaneously allowing more of the ultraviolet light or less of the ultraviolet light to reach a fluorescing media upon which the multispectral watermark is rendered.

In an embodiment, the multispectral watermark can be visible with the IR camera.

In an embodiment, the multispectral watermark may be visible with one or more of the IR camera or the ultraviolet light.

In an embodiment, the first lighting condition can comprise office illumination.

An embodiment can further involve creating the metameric pair of inks wherein one ink among the metameric pair of inks reflects high in the infrared spectrum as compared to the other ink among the metameric pair of inks using solid colors of CMYKRGBP (P=paper/white) or at least one spot.

In an embodiment, the metameric pair of inks can appear as the aforementioned single color/pattern at a printed size.

In an embodiment, the fluorescing media can comprise paper.

In an embodiment, the aforementioned instructions can be configured to cause the at least one processor to perform: creating the metameric pair of inks wherein one ink among the metameric pair of inks reflects high in the infrared spectrum as compared to the other ink among the metameric pair of inks using solid colors of CMYKRGBP (P=paper/white) or at least one spot.

In an embodiment, a system for generating a multispectral watermark, can comprise at least one processor and a memory, the memory storing instructions to cause the at least one processor to perform: providing a color pattern that appears a single color/pattern under a first lighting condition; creating a watermark based on the color pattern and under a second lighting condition comprising ultraviolet light, while the watermark is viewable with an infrared camera in an infrared spectrum; and configuring the watermark as a multispectral watermark with a metameric pair of inks with one ink of the metameric pair of inks using more CMYK toners that reflect in the infrared spectrum as compared to the other ink among the metameric pair of inks while simultaneously allowing more of the ultraviolet light or less of the ultraviolet light to reach a fluorescing media upon which the multispectral watermark is rendered.

In an embodiment, a security apparatus, can include a color pattern that appears a single color/pattern under a first lighting condition; a watermark created based on the color pattern and under a second lighting condition comprising ultraviolet light, while the watermark is viewable with an infrared camera in an infrared spectrum; and the watermark can comprise or function as a multispectral watermark created with a metameric pair of inks with one ink of the metameric pair of inks using more CMYK toners that reflect in the infrared spectrum as compared to the other ink among the metameric pair of inks while simultaneously allowing more of the ultraviolet light or less of the ultraviolet light to reach a fluorescing media upon which the multispectral watermark is rendered.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

1. A method for generating a multispectral watermark, comprising:
providing a color pattern that appears as a single color/pattern under a first lighting condition;
creating a metameric pair of inks wherein one ink among the metameric pair of inks reflects high in an infrared spectrum as compared to the other ink among the metameric pair of inks using solid colors of CMYKRGBP (P=paper/white) or at least one spot;
creating a watermark based on the color pattern and under a second lighting condition comprising ultraviolet light, while the watermark is viewable with an infrared (IR) camera in the infrared spectrum; and
configuring the watermark as a multispectral watermark with the metameric pair of inks with one ink of the metameric pair of inks using more CMYK toners that reflect in the infrared spectrum as compared to the other ink among the metameric pair of inks while simultaneously allowing more of the ultraviolet light or less of the ultraviolet light to reach a fluorescing media upon which the multispectral watermark is rendered, wherein the multispectral watermark is verifiable when visible with the IR camera and with the ultraviolet light and wherein the multispectral watermark generated comprises an extra variable data layer in a space where previously only correlation mark data was encoded.

2. (canceled)

3. (canceled)

4. The method of claim 1 wherein the first lighting condition comprises visible light.

5. (canceled)

6. The method of claim 1 wherein the metameric pair of inks appears as the single color/pattern at a printed size.

7. The method of claim 1 wherein the fluorescing media comprises paper.

8. A system for generating a multispectral watermark, comprising:
at least one processor and a memory, the memory storing instructions to cause the at least one processor to perform:
providing a color pattern that appears as a single color/pattern under a first lighting condition;
creating a metameric pair of inks wherein one ink among the metameric pair of inks reflects high in an infrared spectrum as compared to the other ink among the metameric pair of inks using solid colors of CMYKRGBP (P=paper/white) or at least one spot;
creating a watermark based on the color pattern and under a second lighting condition comprising ultraviolet light, while the watermark is viewable with an infrared (IR) camera in the infrared spectrum;
configuring the watermark as a multispectral watermark with the metameric pair of inks with one ink of the metameric pair of inks using more CMYK toners that reflect in the infrared spectrum as compared to the other ink among the metameric pair of inks while simultaneously allowing more of the ultraviolet light or less of the ultraviolet light to reach a fluorescing media upon which the multispectral watermark is rendered wherein the multispectral watermark is verifiable when visible with the IR camera and with the ultraviolet light and wherein the multispectral watermark generated comprises an extra variable data layer in a space where previously only correlation mark data was encoded.

9. (canceled)

10. (canceled)

11. The system of claim 8 wherein the first lighting condition comprises visible light.

12. (canceled)

13. The system of claim 8 wherein the metameric pair of inks appears as the single color/pattern at a printed size.

14. The system of claim 8 wherein the fluorescing media comprises paper.

15. A security apparatus, comprising:
a color pattern that appears as a single color/pattern under a first lighting condition;
a metameric pair of inks created wherein one ink among the metameric pair of inks reflects high in an infrared spectrum as compared to the other ink among the metameric pair of inks using solid colors of CMYKRGBP (P=paper/white) or at least one spot;
a watermark created based on the color pattern and under a second lighting condition comprising ultraviolet light, while the watermark is viewable with an infrared (IR) camera in the infrared spectrum; and
the watermark comprising a multispectral watermark created with the metameric pair of inks with one ink of the metameric pair of inks using more CMYK toners that reflect in the infrared spectrum as compared to the other ink among the metameric pair of inks while simultaneously allowing more of the ultraviolet light or less of the ultraviolet light to reach a fluorescing media upon which the multispectral watermark is rendered, wherein the multispectral watermark is verifiable when visible with the IR camera and with the ultraviolet light and wherein the multispectral watermark generated comprises an extra variable data layer in a space where previously only correlation mark data was encoded.

16. (canceled)

17. (canceled)

18. The security apparatus of claim 15 wherein the first lighting condition comprises visible light.

19. (canceled)

20. The security apparatus of claim 15 wherein the metameric pair of inks appears as the single color/pattern at a printed size.
